(19) United States
(12) Patent Application Publication
(10) Pub. No.: US 2019/0111366 A1
(43) Pub. Date: Apr. 18, 2019

(54) Fluid Filter

(71) Applicant: Mahle International GmbH, Stuttgart (DE)

(72) Inventors: Anna Eichner, Grunbach (DE); Andreas Kollmann, Eitweg (AT); Werner Schadler, Leibnitz (AT); Gerald Scharfer, Griffen (AT); Mario Wetzl, Kuehnsdorf (AT)

(21) Appl. No.: 15/998,804

(22) Filed: Aug. 16, 2018

(30) Foreign Application Priority Data
Aug. 16, 2017 (DE) 102017214281.2

(51) Int. Cl. B01D 35/18; B01D 29/11; H05B 3/44

(52) U.S. Cl. CPC B01D 35/18; H05B 2203/02; H05B 3/44; B01D 29/11

(57) ABSTRACT

A fluid filter may include a filter housing in which a ring filter element is arranged and an electric heating device configured to prevent freezing of a fluid to be filtered. The electric heating device may be structured as a separate assembly and include a heating housing. The heating housing may be structured substantially complementarily to an external geometry of the filter housing such that the heating device is at least one of slidable and clipable onto the filter housing. The heating housing may at least partially enclose the filter housing when at least one of slid and clipped onto the filter housing.

### CROSS-REFERENCE TO RELATED APPLICATIONS

This application claims priority to German Patent Application No. DE 10 2017 214 281.2, filed on Aug. 16, 2017, the contents of which are hereby incorporated by reference in its entirety.

### TECHNICAL FIELD

The present invention relates to a fluid filter having a filter housing having a ring filter element and a heating device which makes possible heating of the filter fluid. Apart from this, the invention relates to a heating device of such a fluid filter.

From EP 2 299 079 B1 a generic fluid filter with a filter housing is known, a heating device being additionally provided, which heats the filter housing.

From DE 10 2014 216 385 A1 a further generic fluid filter is known, which comprises a filter housing with a receptacle, into which a heating device can be inserted.

### BACKGROUND

In the case of fluid filters, in particular water filters, filter devices for diesel fuel or urea, being optionally able to heat the same is generally the requirement in order to be able to prevent freezing or slushing-up at low temperatures. For example in modern internal combustion engines, water as cleaned substance is sprayed directly into a combustion chamber for cooling. Urea is a watery ammonia solution intended to convert the NOx components that are present in the exhaust system into water and nitrogen. Because of its polarity, diesel fuel in turn has a high affinity to water, which is why the water content compared with petrol is significantly elevated. Since for example the three mentioned fluids thus contain a considerable proportion of water, which freezes at temperatures below 0° C., these fluids have to be heated for proper operation of the fluid filter and of the downstream units if required.

Generally, for this purpose there are a wide range of different possibilities, directly heating the fluid by means of so-called PTC elements being particularly preferred to date. Directly heating the fluid, however, has the disadvantage that much heat is additionally also passed on into the surroundings, which requires an increased energy input.

### SUMMARY

The present invention therefore deals with the problem of stating an improved or at least an alternative embodiment for a fluid filter of the generic type, which in particular overcomes the disadvantages known from the prior art.

According to the invention, this problem is solved through the subject of the independent claim(s). Advantageous embodiments are subject of the dependent claims.

The present invention is based on the general idea of no longer directly heating a fluid in a fluid filter, in particular for protecting against freezing or slushing-up, but providing a filter housing of the fluid filter with a heatable thermal insulation and thereby preventing in particular an undesirable heat dissipation into the surroundings. Here, the fluid filter according to the invention comprises in the usual manner a filter housing, in which a filter element, in particular a radial-flow ring filter element is arranged. For heating the fluid to be filtered, an electric heating device is provided, which according to the invention is now designed as a separate assembly, and comprises a heating housing which is substantially designed complementarily to the external geometry of the filter housing of the fluid filter, so that the heating device can be slid or clipped onto the filter housing and with assembled heating device with the heating housing at least almost completely encloses the filter housing. Here, the heating housing does not only exclusively serve for heating the filter housing and thus indirectly also the fluid flowing in the filter housing, but at the same time also for thermally insulating the filter housing. Because of the, in the cross section, substantially C-shape of the heating housing, the filter housing can be preferentially almost completely enclosed with the same, as a result of which full and thus also even heating of the filter housing and thus of the fluid arranged therein is possible. By forming the electric heating device as a separate assembly, it is possible, in addition, to achieve a simple prefabrication of the heating device, wherein, because of the possibility of sliding or clipping the heating housing onto the filter housing of the heating device, a comparatively simple yet reliable assembly or disassembly can also be achieved. A simple disassembly, in particular, makes possible a significant improvement in terms of maintenance. Here it is obviously clear that the filter housing and thus also the heating housing that is designed complementarily thereto are usually designed round, wherein obviously, purely theoretically, all other embodiments of the filter housing and accordingly obviously also of the heating housing are also possible.

With the heating device according to the invention, the fluid to be filtered in the fluid filter is thus no longer properly heated but rather the filter housing thermally insulated towards the outside and freezing of the fluid merely prevented by means of the heating device. In the case of a stationary vehicle, in which such a fluid filter is installed, the fluid is usually extracted or drained from the fluid filter so that the heating device has to merely during the operation of the fluid filter ensure that the fluid to be filtered, for example diesel fuel or water, does not freeze or slush up. By way of this, a significantly lower energy expenditure is required compared with previous heating devices, which also has, in particular, a positive effect on the entire energy balance of the motor vehicle.

In a further advantageous embodiment of the solution according to the invention, the heating housing is formed from plastic and comprises a heat-conducting element which is located inside and in particular sleeve-like. Obviously, this only applies to the application with a cylindrical filter housing. If the filter housing has another cross section, the cross section of the heating housing and of the heat-conducting element are matched thereto. The sleeve-like heat-conducting element can for example consist of aluminium and because of this favourably conduct heat on the one hand and merely have a low weight on the other hand.

Practically, a plastic covering of the at least one heat-conducting element is smaller in the direction of the filter housing, i.e. radially towards the inside than towards the outside. Because of this, a significantly improved heat transfer of the heat-conducting element to the filter housing and thus to the fluid to be heated in the filter housing can be achieved and on the other hand a significantly improved thermal insulation towards the outside because of the greater plastic covering there. Purely theoretically it is even conceivable here that the plastic covering of the at least one heat-conducting element in the direction of the filter housing is merely designed as a film layer or not at all or only at least partly covering the heat-conducting element, as a result of which a significantly improved heat transfer and thus a significantly improved heating effect can once more be achieved.

Practically, the heating housing comprises a receptacle for inserting the heating element, in particular a so-called PTC heating element. By way of the multi-part embodiment of the heating device, which comprises at least the heating housing and the heating element, merely the heating element has to be replaced during maintenance whereas the heating housing can continue to be used. Obviously, a one-part embodiment is also conceivable. PTC elements (positive temperature coefficient thermistors) are PTC thermistors which usually consist of a semi-conductive polycrystalline ceramic. In addition to this, PTC elements have a temperature-dependent electrical resistance that belongs to the group of the thermistors. At lower temperatures, electric current is thus conducted better than at higher temperatures, as a result of which the PTC heating element, in terms of emitting the heating output as a function of the respective temperature present, regulates itself. Such PTC heating elements are already widespread and have been tested over many years and because of this are particularly well suited for the present case.

In a further advantageous embodiment of the solution according to the invention, the receptacle for the heating element on the heating housing is formed cylindrically and the heating element additionally comprises a collar formed complementarily thereto, on which a sealing element is arranged, so that the heating element via the collar and the sealing element can be tightly inserted into the receptacle on the heating housing. By way of this it is not only possible to achieve simple assembling and disassembling of the heating element in the receptacle, but also a reliable sealing, so that in the assembled state no moisture and in particular also no liquid can enter the receptacle from the outside. Here it is obviously also conceivable that the receptacle for the heating element on the heating housing is formed oval and the heating element additionally has an oval collar that is formed complementarily thereto, as a result of which a unique installation position can be imposed. Such a unique installation position can also be achieved with the positioning elements described in the following paragraph.

In a further advantageous embodiment of the solution according to the invention, on the heating housing a first positioning contour and on the heating element a second positioning contour interacting with the same and formed complementarily thereto are provided, which impose a unique installation position of the heating element in the receptacle. This offers the major advantage that an assembly of the heating element in the receptacle is possible without problems even for unpractised workers, since the first and second positioning contour only allow a single possible installation position, in which the heating elements, which is usually formed as rod-type element and has an electrical plug connection, heat-transferringly lies against the at least one heat-conducting element. An incorrect assembly of the heating element in the receptacle and thus a malfunctioning of the heating device can thus be reliably excluded.

Practically, the fluid filter is formed as fuel filter, as water filter or as urea filter. This non-conclusive enumeration already serves to illustrate the manifold possible applications that exist for the fluid filter according to the invention and the electric heating device according to the invention that is still described in the following.

Practically, on the filter housing at least one engagement contour and on the heating housing of the heating device at least one counter-engagement contour formed complementarily thereto are arranged, which allow fixing of the heating device on the filter housing. Such an engagement contour or counter-engagement contour can be formed for example by a suitable annular groove on the filter housing and a bead on the heating housing formed complementarily thereto and engaging in the groove, as a result of which on the one hand a simplified assembly is made possible while on the other hand, however, a position-precise and simultaneously reliable positioning and fixing of the heating device on the filter housing can be achieved.

Moreover, the heating device and in particular the heating housing of the same can be formed as retainer for retaining the filter housing and/or for fixing to a further component, for example to a motor component or a body of a motor vehicle. Because of this, an additional attachment and/or retaining means can be dispensed with and the heating housing assigned an additional function at the same time. Because of this, in particular the parts variety and thus the storage and logistics costs can be reduced.

Practically, the first positioning contour can be formed as engagement hook and the second positioning contour as through-opening, which offers the major advantage that the first positioning contour formed as engagement hook engages in the second positioning contour formed as through-opening and because of this makes possible fixing the heating element on the heating housing.

In addition to this, the heat-conducting element comprises a bulge preferentially in the region of the heating element, with which the heat-conducting element preferentially lies areally against the heating element, i.e. in particular against the PTC heating element of the same and because of this makes possible an optimal heat transfer. This bulge additionally stiffens the heating housing and can thus also serve as stiffening element.

Furthermore, the present invention is based on the general idea of stating an electric heating device for the fluid filter described before, the electric heating device comprising an in particular cylindrically formed heating housing. By way of this heating housing, the electric heating device can be comparatively easily fitted or clipped or slid onto a filter housing of the fluid filter. The heating housing is formed from plastic and comprises at least one in particular sleeve-like heat-conducting element located inside, preferentially from aluminium. Located inside in this case is to mean that the heat-conducting element is completely covered with plastic and, here, covered with a plastic covering that is thinner radially to the inside than radially to the outside or that the heat-conducting element is only covered with a very thin plastic film or not at all towards the inside and because of this, during the assembly, lies against the filter housing directly or almost directly, i.e. merely by way of a thin plastic film. Because of this, a protected arrangement of the at least one heat-conducting element is possible on the one hand and both an optimised heat transfer to the filter housing and thus to the fluid to be heated and also an improved insulation towards the outside on the other hand, since the plastic covering is thicker towards the outside than towards the inside.

The heat-conducting element has a longitudinal slot.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

In the drawings,

FIG. 1A shows schematically a sectional representation through a fluid filter according to the invention without heating device,

FIG. 1B shows schematically a sectional representation as in FIG. 1A, however with heating device arranged on the filter housing,

FIG. 1C shows schematically a transparent representation of the heating device for illustrating the position of a heat-conducting element arranged in the heating housing of the heating device,

FIG. 2 shows schematically an exploded representation of the heating device according to the invention,

FIG. 3 shows schematically a view of the heating device obliquely from below,

FIG. 4 shows schematically a sectional representation through the heating device according to the invention,

FIG. 5 shows schematically a partly transparent representation of the heating device,

FIG. 6 shows schematically an exploded representation of the heating device according to the invention with an alternative embodiment,

FIG. 7 shows schematically a view of the heating device from FIG. 6 obliquely from below,

FIG. 8 shows schematically a sectional representation through the heating device according to the invention from FIGS. 6 and 7,

FIG. 9 shows schematically a partly transparent representation of the heating device according to FIGS. 6 to 8.

### DETAILED DESCRIPTION

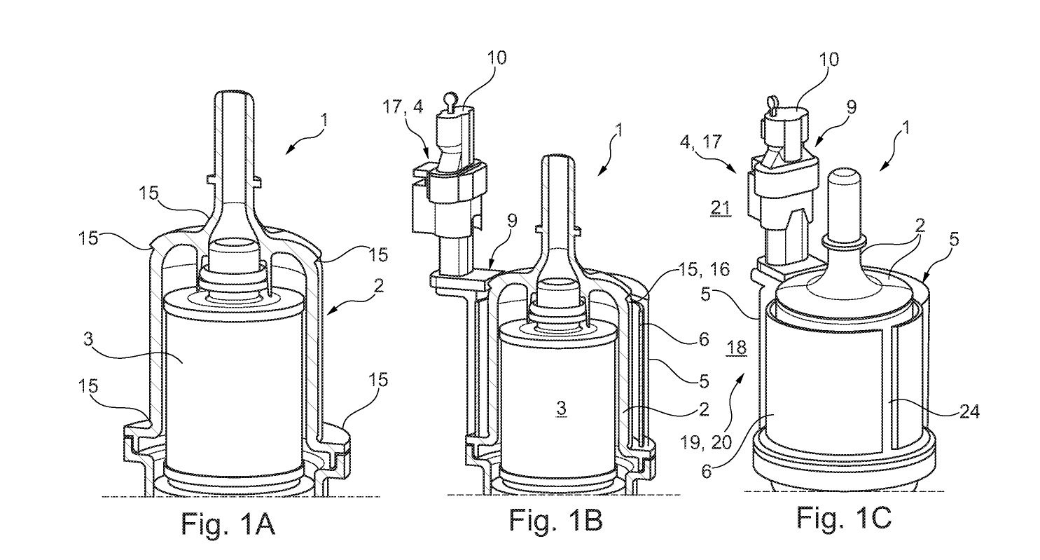

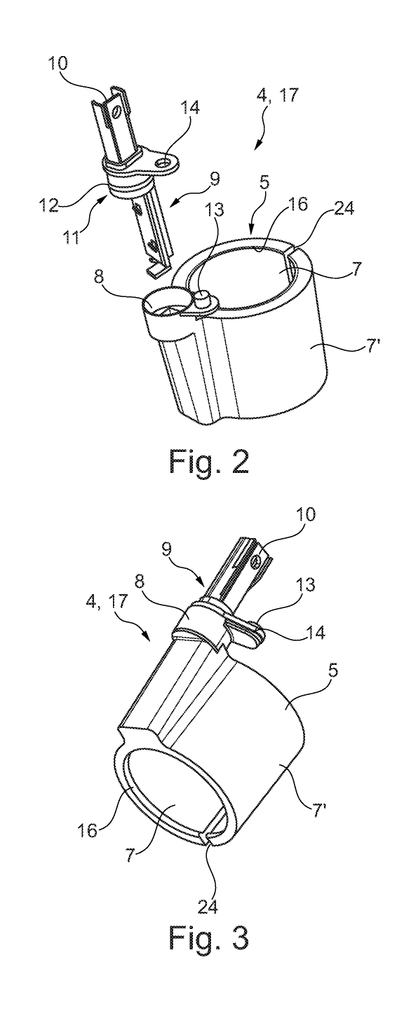

According to FIG. 1A to 1C, a fluid filter 1 according to the invention comprises a filter housing 2, in which a filter element, here a ring filter element 3, is arranged. Here, the filter housing 2 can be usually formed from a filter housing bowl and a filter housing lid that can be screwed or clamped to the same. Obviously it is clear in this case that the filter housing 2 and the associated ring filter element 3 need not be necessarily formed cylindrically, but can also have an other shape. Furthermore, provided is a heating device 4 (see also FIGS. 2 to 9), by means of which heating of the fluid to be filtered, better expressed preventing the freezing of the same, is made possible. The electric heating device 4 according to the invention is formed as a separate assembly, as is also shown according to FIGS. 2 to 9, and comprises a heating housing 5 which is substantially formed complementarily to the external geometry of the filter housing 2, so that the heating device 4 can be slid or clipped onto the filter housing 2 and with assembled heating device 4 with the heating housing 5 at least almost completely encloses the filter housing 2, as is indicated according to FIG. 1C.

Thus, with the heating device 4 according to the invention, the fluid to be filtered in the fluid filter 1 is essentially no longer regularly heated as previously, but the filter housing 2 is rather thermally insulated towards the outside and merely a freezing of the fluid prevented by means of the heating device 4. With a stationary vehicle, in which such a fluid filter 1 is installed, the fluid is usually extracted or drained from the fluid filter 1 so that the heating device 4 merely has to ensure during the operation of the fluid filter 1 that the fluid to be filtered, for example diesel fuel or water, does not freeze or slush up. By way of this, a significantly lower energy consumption is required compared with previous heating devices which in particular also has a positive effect on the entire energy balance of the motor vehicle.

Here it is not only the fluid filter 1 with such a heating device 4 that is to be protected by the present invention, but also the heating device 4 as such. Generally it is true here that the heating housing 5 of the heating device 4 is formed from plastic and comprises an in particular sleeve-like heat-conducting element 6 located inside. This heat-conducting element 6 is obviously merely sleeve-like if the filter housing 2 and the heating housing 5 are also designed cylindrically. Sleeve-like in this case also means a sleeve provided with a longitudinal slot 24. The at least one heat-conducting element 6 in this case is preferentially formed from aluminium and because of this able to perform an optimum heat transfer with low weight. Because of the in particular sleeve-like embodiment of the at least one heat-conducting element 6, a complete enclosing of the filter housing 2 can be achieved and thus an even heating of the same take place, as a result of which in particular so-called hot spots can be avoided. By way of the even heating, the maximum heating temperature can also be lower than was the case with conventional heating devices from the prior art. Obviously, this also results in a reduction of the required energy consumption.

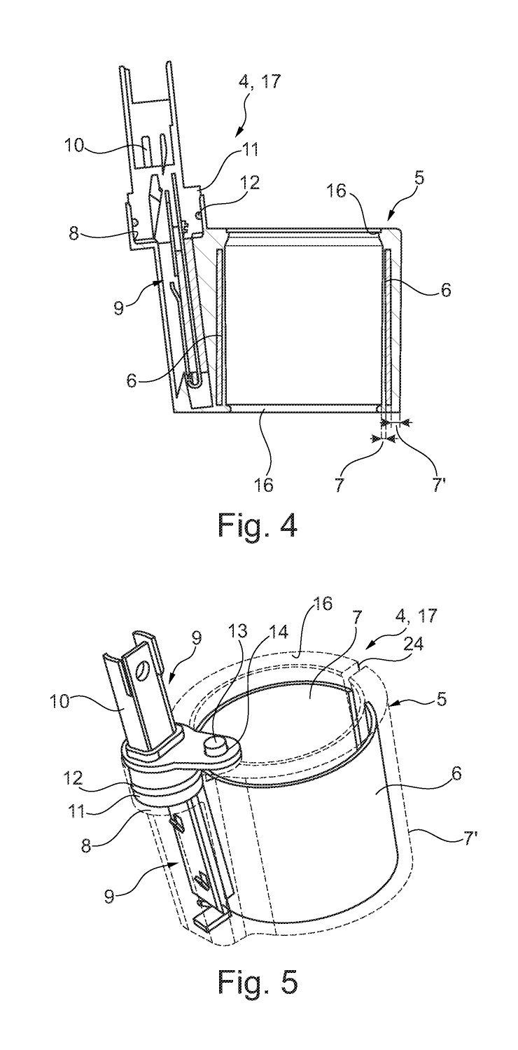

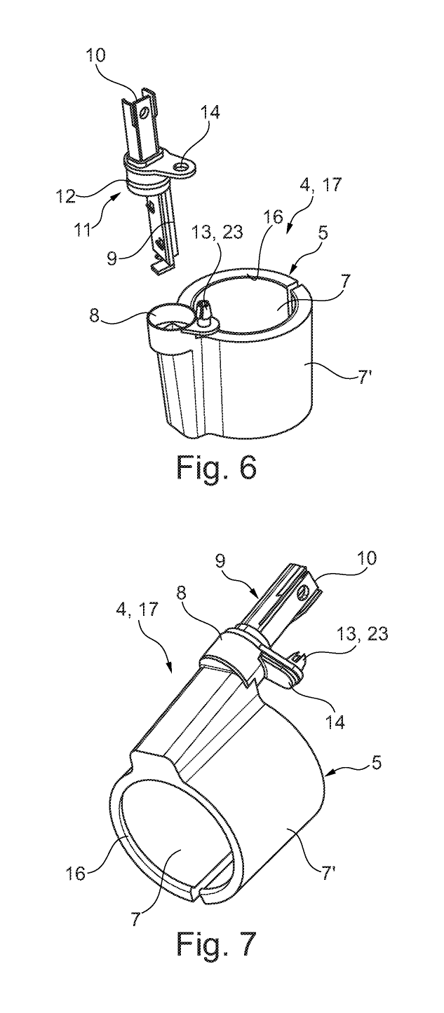

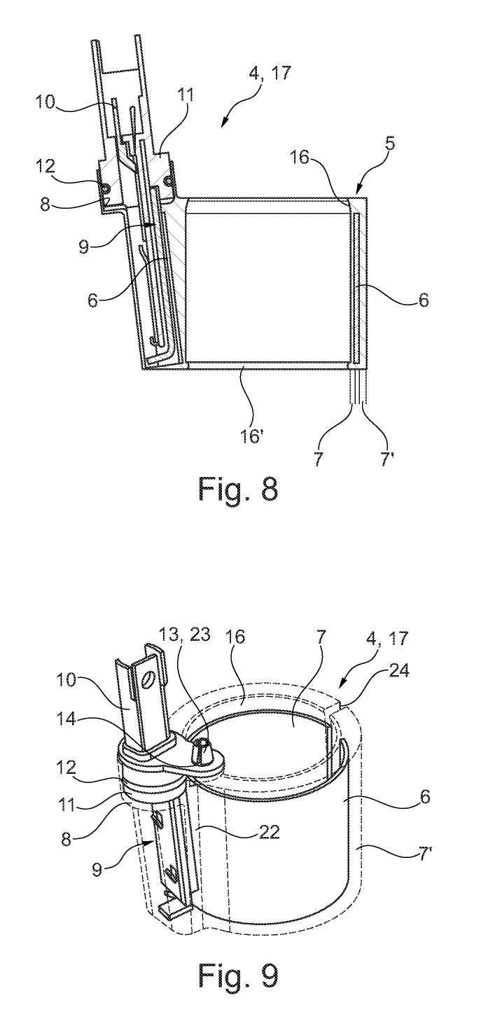

Looking at the heating housing 5 of FIGS. 4 and 8 in more detail, it is evident that a plastic covering 7 of the at least one heat-conducting element 6 in the direction of the filter housing 2, i.e. in the present case radially to the inside, is smaller than a plastic covering 7′ radially to the outside. Because of this, significantly improved heat transfer to the inside, i.e. in the direction of the filter housing 2 and thus of the fluid to be heated can be achieved and simultaneously an improved thermal insulation towards the outside. Here it is obviously clear that the at least one heat-conducting element 6 can also be completely covered with a plastic covering 7 radially to the inside, but does not have to be, so that in a possible and special embodiment the at least one heat-conducting element 6 is not or only partially covered with a plastic covering 7 towards the inside and thus lies for example directly or at least partially directly against an outer lateral surface of the filter housing 2. However, a complete enclosure of the at least one heat-conducting element 6 with plastic is preferred, by way of which the same is arranged in a protected manner. Practically, the heating housing 5 comprises a receptacle 8 (see also FIGS. 2 and 6) for inserting a heating element 9, in particular for inserting a so-called PTC heating element. Here, the heating element 9 can be designed as a rod-type heating element with an electrical connection 10 and in the state inserted in the receptacle 8 bear, against the at least one heat-conducting element 6 or at least be connected heat-transferringly with the same. Here, the receptacle 8 for the heating element 9 is formed cylindrically in the shown embodiments, wherein the heating element 9 additionally comprises a collar 11 formed complementarily to the receptacle 8, on which a sealing element 12 is arranged (see in particular FIGS. 2 and 4 to 6 and 7, 8), so that the heating element 9 via the collar 11 and the sealing element 12 can be tightly inserted into the receptacle 8. Because of this, an in particular undesirable ingress of liquids and/or moisture and dust negatively affecting the efficiency of the element 9 can be prevented.

Looking at FIG. 2, 3 as well as 5 to 7 and 9 further, it is evident that on the heating housing 5 a first positioning contour 13 and on the heating element 9 a second positioning contour 14 interacting with the same and formed complementarily thereto are additionally arranged, which impose a unique installation position of the heating element 9 in the receptacle 8. According to FIGS. 2, 3 and 5, the first positioning contour 13 is formed as a pin, whereas the second positioning contour 14 is formed as associated through-opening. Obviously, the positioning contours 13, 14 can also have other embodiments, they merely have to be able to impose a predefined installation position. An alternative embodiment is shown for example by FIGS. 6, 7 and 9, in the case of which the first positioning contour 13 is designed as an engagement hook 23 and the second positioning contour as a through-opening. This embodiment offers the major advantage that the first positioning contour 13 formed as engagement hook/engagement contour 23 in the second positioning contour 14 formed as through-opening, simultaneously makes possible fixing the heating element 9 on the heating housing 5.

As is additionally evident from FIGS. 5 and 9, the heat-conducting element 6 comprises a bulge 22 in the region of the heating element 9, with which the heat-conducting element 6 preferentially lies areally against the heating element 9, i.e. against the PTC heating element of the same for example, and because of this makes possible an optimal heat transfer. Thus, the bulge 22 stiffens the heating housing 5 and can thus also serve as stiffening element.

Additionally or alternatively it is also conceivable here that the receptacle 8 for the heating element 9 on the heating housing 5 is formed oval and the heating element 9 additionally comprises an oval collar 11 formed complementarily thereto, as a result of which a unique installation position can be likewise imposed.

Furthermore, at least one engagement contour 15 can be arranged on the filter housing 2 and on the heating housing 5 of the heating device 4 at least one counter-engagement contour 16 formed complementarily thereto (see in particular FIGS. 1A, 1B, 1C, and 4), which allow a reliable fixing of the heating device 4 on the filter housing 2. Such an engagement contour 15 or counter-engagement contour 16 additionally makes possible a position-defined and reliable fixing of the heating device 4 on the filter housing 2 without additional fixing means. In addition to this, the heating device 4 and in particular the heating housing 5 of the same can be designed as retainer 17 for retaining the filter housing 2 and/or for fixing to a further component 18, for example to a motor component 19 or a body 20 of a motor vehicle 21. Because of this, additional retaining means can be omitted and at the same time the heating housing 5 assigned an additional function.

With the heating device 4 according to the invention and the fluid filter 1 according to the invention, a freezing of fluids containing water in particular can be achieved with simultaneously clearly reduced energy consumption. Since the heating device 4 is additionally designed as attachment part, it can be decided in each case if such a heating device 4 is to be installed or not.

1. A fluid filter comprising:
a filter housing in which a ring filer element is arranged;
an electric heating device configured to prevent freezing of a fluid to be filtered;
the electric heating device structured as a separate assembly and including a heating housing structured substantially complementarily to an external geometry of the filter housing such that the heating device is at least one of slidable and clipable onto the filter housing, the heating housing at least partially enclosing the filter housing when at least one of slid and clipped to the filter housing.

2. The fluid filter according to claim 1, wherein the heating housing is formed from plastic and includes at least one heat-conducting element.

3. The fluid filter according to claim 2, wherein the at least one heat-conducting element is formed from aluminum.

4. The fluid filter according to claim 2, wherein an inside plastic covering of the at least one heat-conducting element is smaller than an outside plastic covering of the at least one heat-conducting element.

5. The fluid filter according to claim 1, wherein the heating housing includes a receptacle structured and arranged to receive a heating element.

6. The fluid filter according to claim 5, wherein the heating element is a rod-type heating element including an electrical plug connection, and wherein the heating element is heat-transferringly connected to the at least one heat-conducting element when arranged in the receptacle.

7. the fluid according to claim 5, wherein the receptacle is cylindrical and the heating element includes a collar complementarily thereto, on which a sealing element is arranged, such that the heating element via the collar and the sealing element are tightly insertable into the receptacle.

8. The fluid filter according to claim 5, wherein the heating housing includes a first positioning contour and the heating element includes a second positioning contour complementarily thereto, the first positioning contour and the second positioning contour defining an installation position of the heating element when arranged in the receptacle.

9. The fluid filter according to claim 8, wherein the first positioning contour is an engagement hook and the second positioning contour is a through-opening.

10. The fluid filter according to claim 2, wherein at least one of:
the fluid filter is one of a fuel filter, a water filer, and a urea filter; and
the filter housing includes at least one engagement contour and the heating housing includes at least one counter-engagement contour complementarily thereto, the heating device fixable on the filter housing via the at least one engagement contour and the at lest one counter-engagement contour.

11. The fluid filter according to claim 1, wherein the heating device is a retainer, wherein the retainer is at least on of i) structured to retain the filter housing and ii) fixable to a component.

12. An electric heating device of a fluid filter comprising:
plastic heating housing structured substantially complementarily to an external geometry of a filter housing of a fluid filter, the heating housing at least partially enclosing the filter housing when one of slid and clipped onto the filter housing; and
at least one sleeve-like heat-conducting element;
wherein an inside plastic covering of the at least one heat-conducting element is smaller than an outside plastic covering of the at least one heat-conducting element.

13. the heating device according to claim 12, wherein the heating housing includes a receptacle structured and arranged to receive a heating element.

14. The heating device according to claim 13, wherein the heating housing includes a first positioning contour and the heating element includes a second positioning contour complementarily thereto, the first positioning contour and the second positioning contour an installation position of the heating element when arranged in the receptacle.

15. The heating device according to claim 14, wherein the first positioning contour is an engagement hook and the second positioning contour is a through-opening.

16. The heating device according to claim 12, wherein the heating housing is a retainer, wherein the retainer is at least one of i) structured to retain the filter housing and ii) fixable to a component.

17. The heating device according to claim 12, wherein the at least one heat-conducting element is formed from aluminum and arranged inside the heating housing.

18. The heating device according to claim 12, wherein the heating housing is cylindrical.

19. The heating device according to claim 13, wherein the heating element is a PTC heating element.

20. A fluid filter comprising:
a filter housing in which a ring filter element is arranged;
an electric heating device configured to prevent freezing of a fluid to be filtered, the electric heating device structured as a separate assembly and including a heating housing structured complementarily to an external geometry of the filter housing; and
at least one sleeve like heat-conducting element arranged within the heating housing;
wherein the heating device is attachable to the filter housing via at least one of a slide connection and a clipped connection, the heating housing at least partially enclosing the filter housing when attached thereto.
